(19) United States
(12) Patent Application Publication
(10) Pub. No.: US 2014/0180953 A1
(43) Pub. Date: Jun. 26, 2014

(54) METHODS AND SYSTEMS FOR CONTROLLED DISTRIBUTION OF PERISHABLE GOODS

(71) Applicant: Purfresh, Inc., Menlo Park, CA (US)

(72) Inventors: Brian J. Westcott, Menlo Park, CA (US); Robert A. Hayes, Palo Alto, CA (US); Claude-Nicolas Fiechter, San Jose, CA (US)

(73) Assignee: Purfresh, Inc., Menlo Park, CA (US)

(21) Appl. No.: 14/105,036

(22) Filed: Dec. 12, 2013

Related U.S. Application Data
(60) Provisional application No. 61/740,252, filed on Dec. 20, 2012.

(51) Int. Cl. A23B 7/152; G06Q 10/08

(52) U.S. Cl. CPC A23B 7/152; G06Q 10/0832
USPC 705/332; 426/231

(57) ABSTRACT

A system for distributing perishable goods includes a remote central control station, a plurality of local control units, and a plurality of mobile storage containers. By wirelessly transmitting information between the remote central control system and local control units, controlled conditions within the associated mobile storage containers can be optimized to preserve the perishable goods within the containers during lengthy transport trips.

### CROSS-REFERENCE

This application claims the benefit of provisional application 61/740,252 (Attorney Docket No. 43690-703.101), filed on Dec. 20, 2012, the full disclosure of which is incorporated herein by reference.

### BACKGROUND OF THE INVENTION

1. Field of the Invention

The present invention relates generally to methods and systems for the controlled distribution of perishable goods. More particularly, the present invention relates to methods and systems for individually controlling storage conditions within multiple storage containers in real time to optimize the preservation and freshness of fruits, vegetables, and other perishable goods therein.

Vegetables, produce, and many other fresh or frozen foods, and also perishable beverages, pharmaceuticals, biologicals, and the like, are called “perishable goods” since they can spoil in relatively short time periods unless stored under conditions which preserve their freshness, typically including controlled temperature and often including a modified atmosphere. Particular conditions for storing specific perishable goods may vary widely, however, and other storage conditions may depend on regulations intended to control insects, pathogens, and the like.

The nationwide and global transport of perishable goods is further complicated by the differences in the initial condition of the goods before loading, the unpredictably of weather and other external conditions encountered during transport, and changes in the delivery times spent aboard ship or other transports. For example, products loaded at an originating port may vary significantly in ripeness even before loading, and the actual delivery time to a destination port may vary significantly from the originally estimated time depending on weather, changes in route, and other uncontrollable factors. Such uncertainties are exacerbated by simultaneous shipment of many different perishable commodities on a single ship, where the ship may stop at various ports while delivering some containers and picking up other containers.

For these reasons, it would be desirable to provide methods and systems for providing both central and local control of conditions within individual storage containers in real time as those containers are being delivered from an originating location to a delivery location. It would be particularly desirable if such systems and methods could accommodate multiple containers on a single ship or other delivery vessel allowing individual control of each container in real time depending both on the nature of the goods within each container and on the external conditions and changes in delivery route encountered by the ship. At least some of these objectives will be met by the inventions described below.

2. Description of the Background Art

Remote central control of conditions in mobile food transportation containers is described in U.S. Pat. No. 6,390,378 and U.S. Pat. No. 6,647,735. Dynamic control of a perishable goods container is described in U.S. Pat. No. 5,872,721. Storage control algorithms that can be selected based on the good being transported are described in U.S. Pat. No. 6,862,499. Dynamic control of gases in a storage container is described in U.S. Pat. No. 7,208,187. Systems for controlling CO2 and O2 levels in storage containers are described in U.S. Pat. Nos. 5,457,963; 5,623,105; 6,007,603; and 6,092,430.

### BRIEF SUMMARY OF THE INVENTION

The methods and systems according to the present invention provide for controlled distribution of perishable goods, typically produce such as fruits and vegetables, but also meats and other fresh foods, wine and other perishable beverages, pharmaceuticals, biologicals, and the like. The perishable goods will be stored and maintained in mobile storage containers, such as standardized shipping containers which are equipped or configured with a local control unit to control conditions within the mobile storage container. The control conditions will determine the storage environment within the container, including temperature; atmosphere, e.g. levels of oxygen, ozone, carbon dioxide, ethylene, and the like; humidity; light and dark cycles; exposure to ultraviolet radiation; exposure to infrared radiation, exposure to ionizing radiation, and the like. Each mobile storage container will typically store a single type of perishable good so that conditions for that particular perishable good can be optimized within the individual container and conditions within other containers optimized for their contents. In other instances, however, it will be possible to store more than one type of perishable goods in a single mobile storage container where the different types of goods may be preserved and maintained under similar controlled conditions.

Each control unit associated with each mobile storage container will be equipped to locally maintain specific controlled parameters at desired values or set points within the mobile storage container. The control unit may comprise a refrigeration unit, a gas generator or reservoir, a radiation source, a light source, and/or other active control elements which are powered and controlled locally. The control unit will usually also include an analog or digital controller where the control parameters or set points are maintained based on a feedback control system, typically including a sensor for the controlled parameter and a controller which adjust the output of the active control unit. The controller may employ any conventional control algorithm, typically proportional control, derivative control, integral control, or combination thereof.

In addition to such control functions, the local control units may include or be associated with sensors which provide sensor functions to allow measurement of the controlled and other conditions, such as temperature, humidity, gas composition, and the like. In addition, other sensors such as accelerometers, may be provided for particular purposes such as for detecting shocks which may accidentally occur to the mobile storage containers, e.g. when the containers are accidentally dropped.

At least some of the set points or control points for the controlled parameters will be determined at, and delivered to the local control unit from, a location remote from the mobile storage unit itself. For example, the systems may comprise one or more remote central control stations which have transmission capabilities which can send control points or set points to each of the mobile storage units individually. Optionally, an intermediate transmission unit may be provided to receive transmissions from the remote central control station and to then retransmit the control points to individual mobile storage units. Such intermediate transmission units will be particularly useful on large ships or trains which carry hundreds of individual mobile storage containers with many different perishable products. Information can be tracked at the remote central control station regarding many factors which determine the control conditions necessary to preserve the perishable goods. For example, the conditions of the goods when they are loaded at a loading facility into the mobile storage containers may be noted at the remote central control station, allowing an initial calculation of the optimum storage conditions for that particular perishable good during the originally planned delivery route. A particular benefit of the present invention, however, is that the remote central control station can keep track of changes in the external conditions to which the mobile storage containers are traveling, changes in routes and destinations, and the like, as well as supply chain management changes from a receiver of the perishable goods. Based on these changes which can occur while the goods are in transit, the conditions needed to optimize and preserve the freshness of each of the different perishable goods in the various mobile storage containers can be changed in real time. Moreover, should the changes in route or external conditions be sufficiently great, it may become necessary to offload particular mobile storage containers at different ports while they still maintain or an acceptable level of freshness when they would otherwise be spoiled by the time they reached their originally intended port.

In a first aspect of the present invention, a method for distributing perishable goods comprises loading perishable goods into one or more mobile storage containers at one or more originating locations. Each mobile storage container will have a local control unit which controls at least one controlled condition within the mobile storage container based upon at least one control parameter, e.g. a set point. Each mobile storage container is transported to a destination location, and one or more local control parameters are wirelessly transmitted or otherwise provided to the mobile storage container from a remote central control station during such transport. In this way, the controlled conditions within the local storage containers can be changed to respond to external conditions, changes in routing of the mobile storage unit, and the like.

In preferred aspects of the present invention, the local control unit will receive at least two local control parameters in order to control at least two local controlled conditions within the mobile storage containers. The local control parameters can be adjusted to change the environmental conditions within the mobile storage container to control at least one of cold-chain integrity, time to ripeness, pathogen control, insect control, decay control, fungal growth, mold growth, product color, product taste, or product appearance, or other parameters that influence product marketability.

The method will typically further comprise measuring a value of one or more controlled conditions within each mobile storage container and transmitting the measured values to the remote central control station. In this way, the remote central control station can determine and transmit updated local control parameters or set points based at least on partly on the measured values of the controlled conditions. The local control parameters will, however, also be based on a variety of other conditions which can tracked at the remote central control station, including scheduling factors nature of the perishable goods, harvesting conditions of the perishable goods, shipment conditions of the perishable goods, the route of shipment and changes in route of shipment, adverse or other events which occur during shipment, regulatory requirements which may change depending on the port at which the perishable goods are to be delivered, supply chain management changes, changes in instructions from a receiver of the perishable goods, and the like. A central benefit of the present invention is that the local control parameters and set points may be periodically changed. The changes may be in response to a set pattern when a set pattern can be pre-determined but will more commonly be made in response to change in real time.

The methods of the present invention may further comprise generating an alert signal in response to an adverse event in a mobile storage container and transmitting the signal to the remote central control station. The remote central control station may optionally initiate a corrective action in response to the alert signal, e.g., sending instructions to the local control unit to take corrective measures and/or alerting personnel at a loading facility or on the ship or other transportation vehicle to inspect the particular mobile storage container or local control unit. In particular, the corrective action may comprise the remote control station changing one or more local control parameters of the local control unit in the mobile storage container in order to reverse or ameliorate the adverse event. Alternatively, the corrective action may comprise the remote control station sending instructions for local personnel to inspect the mobile storage container which has had the adverse event. The adverse event may comprise any one of a wide variety of circumstances, such as a deviation in control temperature, a deviation in control atmosphere, a mechanical shock, a breach in the container seal, or the like.

In a second aspect of the present invention, a system for distributing perishable goods in mobile storage containers comprises a remote central control station and a plurality of local control units. The local control units are configured to be incorporated into or mounted on individual mobile storage containers in order to control at least one controlled condition within the mobile storage container based upon control parameters, e.g. set points, received from the remote central control station. The system provides for wirelessly or otherwise transmitting control parameters from the remote central control station to the control units in order to control conditions within the mobile storage containers, e.g. the environments within set containers. The system allows for changing the control parameters and set points in response to changes in external conditions, changes in transport routes and/or timing, adverse events, and the like. Specific systems may be adapted and constructed to provide any of the controlled protocols described above with respect to the methods of the present invention.

In a third aspect of the present invention, a method for configuring a mobile storage container to be placed on one or more transportation vehicles comprises providing a plurality of mobile storage containers at an originating location, typically a loading facility such as a loading dock, truck loading facility, airport, or the like. At least some of the mobile storage containers will have local control units, and at least some of the local control units will be configured to control local control parameters which are different than the local control parameters controlled by others of the mobile storage containers. Information regarding the amount of a perishable commodity or goods to be transported from said originating location to one or more destination locations is provided to a remote central control station. The remote central control station assigns portions of the perishable goods to specific mobile storage containers based at least partly on the ability of the local control unit to preserve the perishable goods during transportation from the originating location to the destination location. These methods are useful in loading and configuring local control units and/or mobile storage units to be placed on large transportation vehicles, particularly ships and trains. They will also be useful for loading and configuring local control units and mobile storage units to be placed individually on trucks, particularly when loading many trucks at a single loading facility where the routing of the individual trucks can then be planned and conditions monitored during delivery.

In specific embodiments, the remote central control station instructs the local control units of at least some of the mobile storage containers to perform pre-trip inspections to determine if the container is in condition to carry the perishable goods. The remote central control station may provide one or more local control parameters to the individual local control units or the local control parameter(s) may differ for different local control units based on the nature of the commodity and/or the destination location, or other specific circumstances of the trip. The remote central control station may be configured to send an alert to the originating location to inspect a mobile storage container which fails the pre-trip inspection.

In a fourth aspect of the present invention, a method for controlled ripening of a perishable good during transport in a mobile storage container comprises monitoring ambient conditions within the mobile storage container during transport from an originating location to a destination location. Ripeness of the perishable commodity during transport is also monitored, for example, by monitoring ethylene levels, changes in CO₂ or oxygen concentration, or other combinations of parameters within the mobile storage container Ambient conditions within the mobile storage container are then adjusted so that the perishable goods reach a target level of ripeness just as the mobile storage container reaches the destination location.

In specific embodiments, methods for controlled ripening may further comprise perturbing at least one ambient condition to see an effect on at least one ripeness marker which is being monitored. Monitored conditions include temperature, humidity, CO₂ concentration, ethylene concentration, oxygen concentration, and the like. Adjusting ambient conditions typically comprises adjusting temperature but could also comprise adjusting humidity, CO₂ levels, ozone levels, or the like.

Such methods for controlling ripening may further comprise determining an adjustment in ambient condition necessary to achieve the target level of ripeness using a remote central control station. A remote control unit in the mobile storage container is provided to monitor the ambient conditions and ripeness and can transmit data to the remote central control station. The remote central control station in turn transmits data to the local control unit to adjust ambient conditions within the mobile storage container to achieve the target level of ripeness.

In still further specific aspects of this method, information may be provided to the remote central control station which is useful in adjusting the conditions within the mobile storage container to achieve the target ripeness. Such additional information may include scheduling factors, the nature of the perishable goods, the conditions of the perishable goods at harvest, the conditions of the perishable goods immediately prior to loading and shipment, the shipment route, any changes which may occur to the shipment route during the course of shipment, other events during shipment, regulatory requirements, and/or instructions from the shipper or receiver of the perishable goods.

In a fifth aspect of the present invention, a method for cold treating perishable goods during transport from an originating location to a destination location comprises providing a required cold treatment protocol to a remote central control station, e.g. a temperature or other treatment regiment required by the destination location for insect or other pathogen treatment. The temperature within a mobile storage container which holds the perishable goods is monitored during transport, and the monitored temperature transmitted to the remote central control station, typically in real time. The remote central control station is thus able to compare a monitored temperature with the required cold treatment protocol and can transmit a temperature control signal to a local control unit in the mobile transport container as necessary in order to maintain or adjust the temperature within the mobile transport container. In this way, close compliance with the requirements of the cold treatment protocol can be achieved.

In specific aspects of this cold treating protocol method, the remote central control station may terminate the cold treatment protocol after the protocol has achieved a target temperature profile. The remote central control station may also decrease the temperature in the mobile storage container if it appears that the target temperature profile will not be achieved before the mobile storage container reaches its destination location. Further, the remote central controller may record temperature information from the local control unit and prepare a cold treatment report for the individual mobile storage container after the container has reached the destination location. Such a report can be configured for direct submission to the local regulatory agency which oversees the cold treatment requirements for imported perishable goods.

In a sixth aspect, the present invention provides a network for distributing perishable goods using a plurality of mobile storage containers carried by a multiplicity of ships or other transportation vehicles in real time. The network comprises a remote central control station, a loading facility control station and a plurality of local control units. The remote central control station is configured to receive data concerning perishable goods to be transported from originating locations to destination locations. For example, a shipper may submit data concerning amounts of a perishable good that it wishes to ship from a port in one country to a port in a second country (or other location with the originating country if pathogen control between regions is desired). The loading facility control station at a port in the receiving country receives data transmitted from the remote central control station regarding the intended shipment and, can in turn communicate with a plurality of local control units to determine the status of those units and the suitability for shipping the perishable goods which need to be shipped.

In specific aspects, the network is configured so that the remote central control station will transmit data to the loading facility control station to assign particular perishable goods to be loaded into particular mobile storage containers. It will be appreciated that the number and suitabilities of the mobile storage containers may be based on data which is earlier uploaded from the loading facility control station to the remote central control station. Alternatively or additionally, the remote central control station may keep track of specific mobile storage containers as they are shipped among facilities and carry different perishable goods.

In other specific aspects, the loading facility control station transmits data to the remote central control station including the identity of particular mobile storage containers which are available to transport particular perishable goods.

In still further aspects, the remote central control station transmits data to the loading facility control station including local control parameters for a particular mobile storage container, and the remote central control station transmits local control parameter data to the local controllers for the particular mobile storage containers.

The networks may further comprise a transportation vehicle control station configured to receive data from and to transmit data to the remote central control station as well as to and from the local control units. The data transmitted from the remote central control station to the transportation vehicle control station may include local control parameters.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts the main components of a system for distributing perishable goods according to the present invention.

FIG. 2 is a simplified diagram showing an exemplary remote central control station according to the present invention.

FIG. 3 is a simplified diagram illustrating an exemplary local control unit according to the present invention.

FIG. 4 is a block diagram showing information flow between a remote central control station and various information in put sources and local control units.

### DETAILED DESCRIPTION OF THE INVENTION

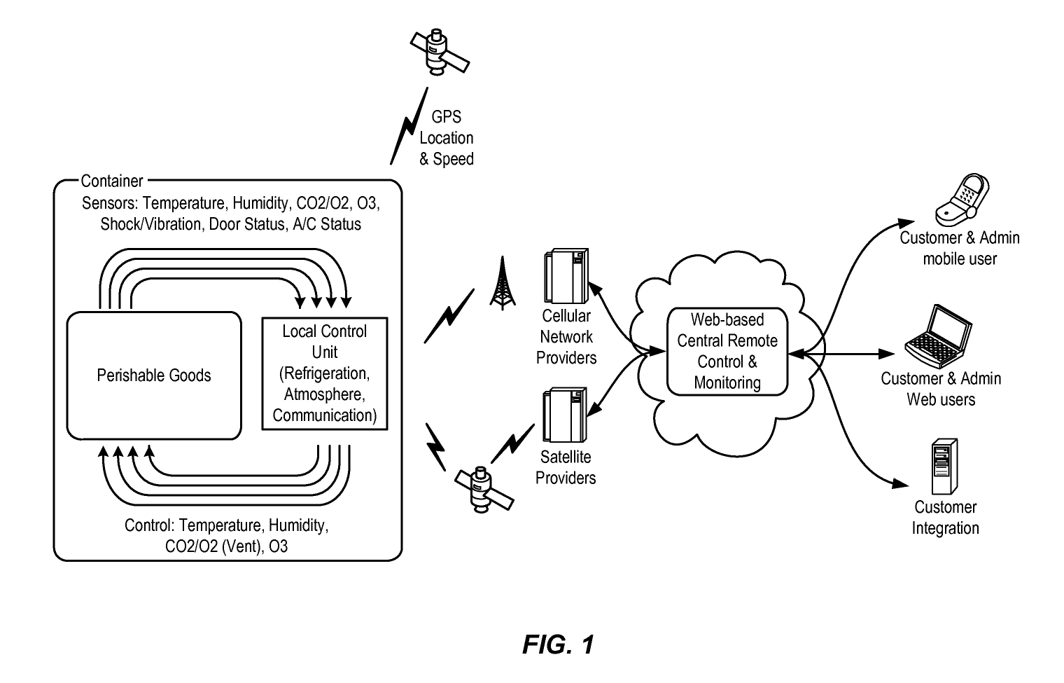

FIG. 1 depicts the main components of the system. A refrigerated container (“reefer”) for the transport of perishable good is equipped with a local control unit. The local control unit can be permanently installed and fully integrated with the refrigeration unit of the container or can be installed temporarily for a shipment and connected to the reefer power and, optionally, to the refrigeration unit's controller.

The local control unit measures the atmospheric conditions inside the container, including temperature, humidity, CO₂, and ozone concentration, and is equipped with sensors to measure acceleration, shocks, and vibrations, the status of the A/C power supplied to the container, and to detect when the doors of the container are open. The local control unit can also measure the location and speed of the container using GPS and can have access to the reefer controller data. These data include the reefer controller operational status, its own temperature measurements, including the external (ambient) temperature, and, in some cases, temperature and humidity measurements from probes inserted in the transported goods and connected to the reefer controller. The units may also include additional sensors, like O₂ or ethylene sensors.

The local control unit uses the sensor data to control the environmental conditions within the container through the refrigeration unit, for temperature and humidity, and through other actuators to control the ozone, CO₂, and O₂ concentration inside the container. The local control algorithm depends on a number of local control parameters, including the set point for the temperature, for the humidity level, and for the ozone and CO₂ concentration, as well as other settings that affect the local control operations (e.g., the frequency and duration of defrost cycles for the refrigeration unit).

The local control unit is equipped with wireless communication modems and can communicate with a central remote control and monitoring station through publicly available communication networks, like cellular telephone networks, satellite networks, and the internet. An exemplary embodiment supports communication through GSM cellular networks and through the Iridium satellite network, and the data is routed from the cellular network and satellite providers to the central remote control and monitoring station via the public internet.

The local control unit sends information about the environmental conditions within the container, its location, its status, and about events it detects to the central remote control and monitoring station at regular intervals and in response to specific events (e.g., power off, alarms, etc.). The central remote control and monitoring station can send data and commands back to the local control unit, either in response to a message from the unit or asynchronously as needed. The data sent from the central remote control and monitoring station can include values for the local control parameters, like set points and operation mode, thresholds for locally detected alarms, etc., as well as updated or fully new versions of the local control algorithms.

The central remote control and monitoring station can monitor and control many local control units simultaneously. It processes and stores the data sent from the local control units to enhance or filter the original information (e.g., geo-coding, geo-fencing, sensor measurements normalization), detect abnormal conditions or events of interest, generate reports, and send user notifications. It provides a user interface that authorized users can access via the public internet, though a mobile application or through a web browser, as well as mechanisms to integrate with the back-end applications from multiple customers, such as customer supply-chain management tools and enterprise resource planning (ERP) systems.

The central remote control and monitoring station can send data and commands to one or more local control unit based on a user action, automatically in response to some information sent by one of the local control units, or based on a command it received from a customer back-end application. These user-initiated or automated commands can be based on a combination of factors, including scheduling factors, information about the commodity being transported or about its condition, the location or route of the container, previous events during the trip, regulatory requirements, and/or requirements from the shipment intended recipient.

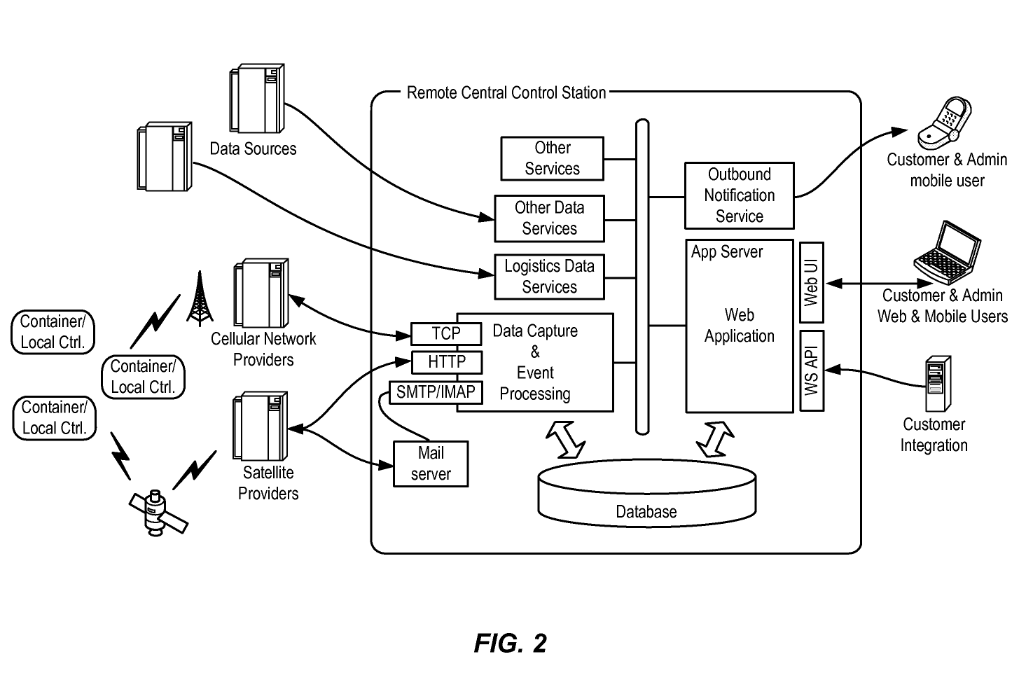

FIG. 2 illustrates an exemplary cloud-based remote central control station useful in the systems and methods of the present invention. The remote central control station can be hosted in a provider's or user's data center or can reside at least partially in the cloud and will provide a number of data processing components typical of large web-based data control services. A remote central control station will receive data from outside data sources, including weather information, routing information, order information, and the like. The remote central control station will also be configured to communicate through all conventional data transmission services, including cellular networks, web-based networks, satellite providers, and the like. Such communication links will serve to connect to the local control units, optional intermediate control units, facility control units, and the like. The communication links will also permit communication from customers, vendors, suppliers, and others.

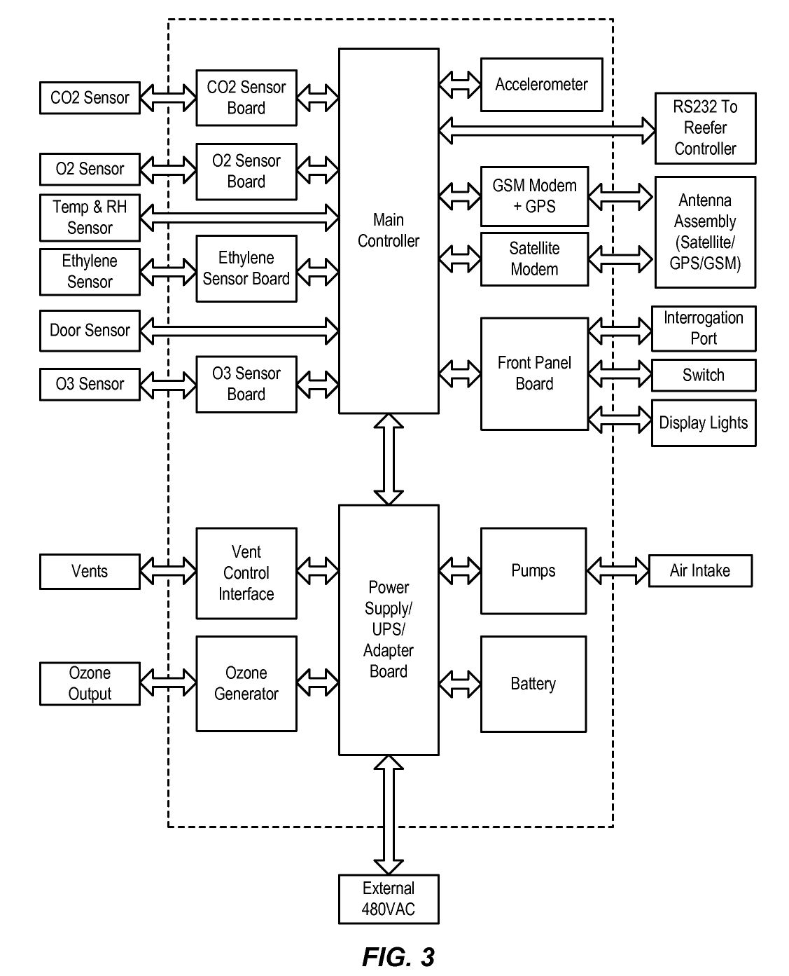

FIG. 3 illustrates an exemplary local control unit which is configured for mounting within a mobile storage unit, typically including a conventional controller having refrigeration and other environmental control capabilities. The local control unit will typically further include sensors for measuring ambient conditions within the mobile storage container, including for example a CO₂ sensor, an O₂ sensor, a temperature sensor, a relative humidity sensor, an ethylene concentration sensor, a door position sensor (to detect whether or not the door is opened or closed), an ozone concentration sensor, and others as needed. The local control unit will be able to actively control temperature and other environment conditions within the mobile storage unit, for example, the local control unit may be able to control the release of gases into and/or from the mobile storage container. Additionally, the local controller will typically be able to inject ozone into the storage unit as needed to control degradation of the perishable goods. Although not illustrated, the local controller could also provide for introduction of carbon dioxide and other preservative gases and materials to within the mobile storage controller. The local control unit will also typically include conventional data input and output ports as well as radio devices to allow communication with external interfaces, and in particular to allow communication with the remote central control station, the loading facility control station, and any intermediate control receivers and stations which may be employed. Furthermore, the local control unit will include a GPS receiver in order to track the position of the mobile storage unit during transport.

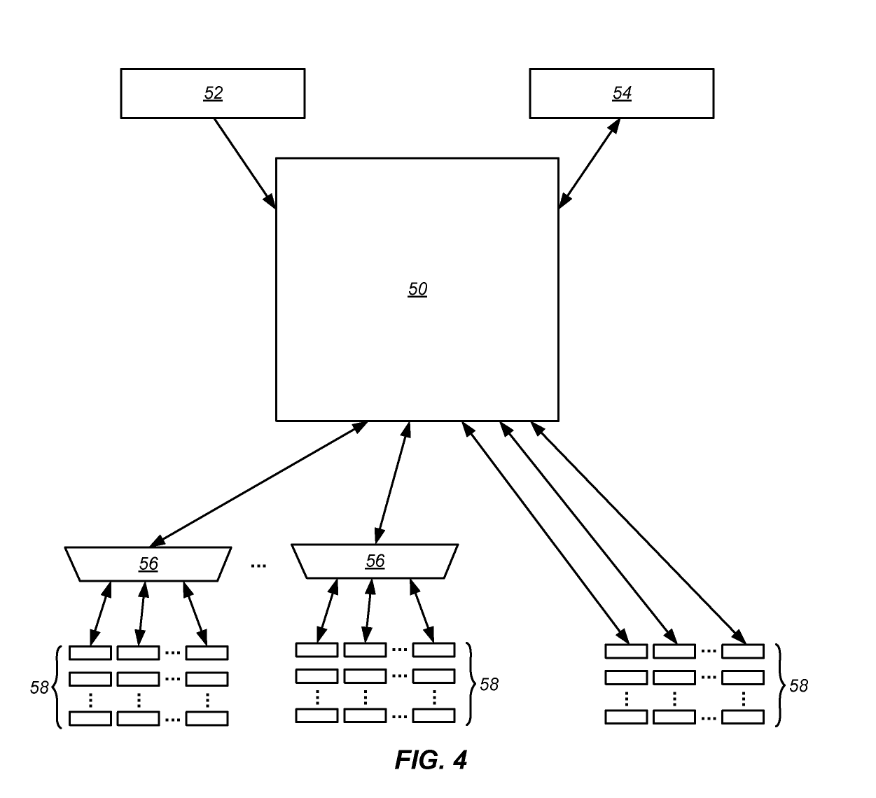

FIG. 4 illustrates a network for distributing perishable goods in accordance with the principles of the present invention comprises, which is configured to receive data from external data sources 52, such as databases showing weather, ship locations, shipping schedules, and other information which may affect the timing or routing of a particular ship or transportation vehicle. The remote central control station will also be configured to receive input from users 54 regarding scheduling, orders, status inquiries, and the like. The remote central control station will also be configured to send and receive data to individual ships or other transportation vehicles 56 which may be located anywhere around the globe, either in port or in route between ports to pick up and deliver perishable goods. The perishable goods are contained in a plurality of shipping containers 58 which are being transported by each individual ship 56 or other transportation vehicle. The network provides for two-way communication from each of the storage containers 58 to the central control station 50, either directly to the containers 58 or indirectly via intermediate control stations (not illustrated) present on each of the ships 56 or other transportation vehicles, with both direct and indirect communication being illustrated in FIG. 4. Using this network, the methods of the present invention which have been previously described may be efficiently carried out.

### EXAMPLES

In instances where several containers of a commodity are shipped to a retailer, based on the harvesting and pre-shipment condition of the commodity (provided by the grower) and based on requirements from the retailer, different local control parameters can be set to achieve different degrees of ripeness at the arrival in each of the containers, with the commodity in some of the containers ready for immediate distribution whereas the commodity in the others may be intended for later distribution.

If a container appears to be “stuck” at a location for longer than expected, the local control parameters can be remotely changed to slow down the ripening, to still achieve the desired degree of ripeness at arrival.

If an unexpectedly long power outage is noted for one or more containers (as it often happen during transshipment or while the ship is waiting to cross a canal) the local control parameters can be temporarily changed after the power comes back (e.g., increase ozone set point) to try to limit the growth of mold and otherwise mitigate the impact on the commodity of the extended period without refrigeration and atmosphere control.

If, based on data from a pre-trip inspection or test (which result may not have been available prior to departure), or from the arrival condition of another shipment of the same commodity, the shipper suddenly realizes that the commodity is not in as good a condition it had anticipated or has a higher-than-expected probability to be contaminated by some pathogen, the local control parameter can be remotely changed to control pathogens more aggressively or to try to mitigate the weaker starting condition of the commodity.

“Cold Treatment” protocols are used to control insects by providing a sustained low temperature over a time period as prescribed by the U.S. Department of Agriculture (USDA) for some commodities imported from different countries. Using the systems of the present invention, when cold treatment is required, a trip can be started with a low temperature set point to achieve the requirements of the cold treatment. Once the requirements of the cold treatment have been achieved, the cold treatment can be certified by the regulating authority based on measured data transmitted back to the remote central control station and forwarded the authority. In order to approve a cold treatment protocol, the (USDA) requires an actual data download from the controller of the refrigerated mobile transportation container. Instead of having to wait for the container to arrive at its destination to have the log manually downloaded, the system of the present invention allows a shipper to remotely initiate the download and receive and archive the log while the container is still on board the ship. This allows the log to be electronically forwarded for approval to the USDA. If desired to improve quality of the perishable goods or for other reasons, the remote control station can then instruct the local controller to raise the temperature to achieve better fruit condition or taste at the end of the trip.

Conversely, if during a cold treatment, the system detects that the shipment is failing or likely to fail to achieve the needed temperature profile, the temperature set point can be remotely decreased to further decrease the pulp temperature of the fruit or other perishable good. Once the cold treatment is successfully completed and confirmed, a less damaging temperature set point can be restored, like in the example above.

The systems of the present invention also allow for improved loading and set up of mobile storage containers at a loading facility, such as a loading dock, a truck loading center, or an air transport location. For example, a loading facility may receive a booking for the shipment of N containers of a particular commodity. Using a planning/inventory system in accordance with the present invention, the remote control station can identify N mobile storage containers and/or local control units which are available at the loading facility and which are suitable for the commodity and the trip. The loading facility can have personnel visually inspect the identified containers and can turn on the local controllers. The remote central control station can then remotely initiate an automated pre-trip inspection (PTI) on each of the container (e.g., a short PTI, a full PTI, a chilled PTI, etc.), taking into account when the last full PTI was performed and the nature of the last commodity to be transported in the particular container (which information can be archived in the remote central control station). When the PTI complete (which may take several hours), the remote central control station automatically and remotely receives a detailed report. If the mobile storage containers and local control units pass the PTI, they are remotely configured by the remote central control station for the booked commodity by inputting, for example, a temperature set point, a humidity set point, and other local control parameters, as appropriate. The mobile storage containers are then ready for pick-up and loading.

In contrast, if any of the mobile storage containers and/or local control units fails the PTI, the remote central control station can alert the loading facility to dispatch a technician to fix the mobile storage container(s) and/or local control unit(s) and/or can identify replacement container(s). The remote central control station can also provide specific diagnostic information to aid the technician if repairing the mobile storage container(s) and/or local control unit(s).

The systems of the present invention can also monitor for damages to the individual mobile storage containers and/or local control units due to accidents, storms, or other adverse conditions during loading and transport. For example, a container that is ready for a shipment and has passed its PTI may be dropped while it is being moved at the terminal. The local control unit may be equipped with an accelerometer which detects the stronger-than-usual shock (a sudden acceleration above a given threshold). The controller can then transmit an alert to the remote central control station, which then notifies the loading facility, the carrier company, or others. Typically, the remote central control station will initiate an additional PTI (automated pre-trip inspection) to verify that the mobile storage container and/or local control unit was not damaged by the drop. Similar alerts can be sent out at any point during the transportation when the local control unit detects any event or condition out of the ordinary which may be associated with damage to or failure of a mobile storage container and/or local control unit.

The systems of the present invention can also monitor for unintended interference or tampering with individual mobile storage containers before, during, or after transportation of the container. For example, the doors of a container carrying commodities being shipped under a modified atmosphere (e.g., low oxygen/high CO2) may be accidentally opened during trip. The local control unit can detects the door breach and sends an alert to the remote central control station, which can in notify the vessel and/or the shipper. After reviewing sensor data from the unit, the remote central control station and/or the shipper may conclude that the modified atmosphere inside the container has been compromised. It may then be possible for the remote central control station to change the local control parameter to reverse or mitigate the loss perishable goods resulting from the modified atmosphere (e.g., lower the temperature to slow the respiration and increase ozone production to control mold).

The systems of the present invention can also be used to promote and control ripening of the perishable goods during transportation. For example, using a knowledge of the degree of ripeness of the goods prior to loading and feedback on ripeness obtained from sensors in the container operating during the trip, ripening may be initiated and controlled based on the estimated time to arrival at the destination location. As time and conditions change, the container conditions may be adjusted, e.g. by altering the container atmosphere, so that the goods reach a target level of ripeness by the time they are unloaded. To estimate the present state of ripeness, the system could remotely create a known perturbation of a control parameter such as temperature to assess the effects on the commodity and to estimate the present state of the commodity relative to methods to induce ripening. From this information along with ongoing trip information, a specific control protocol can be calculated and remotely introduced and controlled on the container from the remote central control station.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for distributing perishable goods, said method comprising:
loading perishable goods into one or more mobile storage containers at one or more originating locations, wherein each mobile container has a local control unit which controls at least one controlled condition within the mobile storage container based upon at least one local control parameter;
transporting each mobile storage container to a destination location;
providing one or more local control parameters for one or more controlled conditions from a remote central control station to each local control unit to change one or more controlled conditions within the mobile storage container while the mobile storage container is being transported.

2. A method as in claim 1, wherein the one or more local control parameters are wirelessly transmitted to each local control unit.

3. A method as in claim 1, wherein the local control unit receives at least two local control parameters to control at least two local control conditions within the mobile storage container.

4. A method as in claim 1, wherein the set point(s) change the environmental condition(s) to control at least one of cold-chain integrity, time to ripeness, pathogen control, insect control, decay control, fungal growth, mold growth, product color, product taste, product appearance, or other parameters that influence product marketability.

5. A method as in claim 1, further comprising measuring the value of one or more controlled conditions within each mobile storage container and transmitting the measured values to the remote central control station.

6. A method as in claim 5, wherein the transmitted local control parameter(s) are determined at least partly on the measured value(s) of the controlled conditions.

7. A method as in claim 1, wherein the transmitted local control parameter(s) are at least partly determined based on scheduling factors, nature of the perishable goods, a harvesting condition of the perishable goods, a pre-shipment condition of the perishable goods, a route of shipment, a change of shipment route, an event during shipment, regulatory requirements, and instructions from a receiver of the perishable goods.

8. A method as in claim 1, wherein at least one local control parameter is periodically changed.

9. A method as in claim 4, wherein at least one local control parameter is periodically changed in response to a set pattern.

10. A method as in claim 9, wherein said at least one local control parameter is periodically changed in response to the measured value(s) of the controlled conditions.

11. A method as in claim 1, further comprising generating an alert signal in response to an adverse event in a mobile storage container and transmitting the signal to the remote central control station.

12. A method as in claim 11, wherein the remote central control station initiates a corrective action in response to the alert signal.

13. A method as in claim 12, wherein the corrective action comprises the remote central control station changing one or more local control parameters in the mobile storage container which has had the adverse event.

14. A method as in claim 12, wherein the corrective action comprises the remote central control station sending instruction for local personnel to inspect the mobile storage container which has had the adverse event.

15. A method as in claim 11, wherein the adverse event comprises a deviation in control temperature, a deviation in control atmosphere, a mechanical shock, or a breach in the container seal.

16. A system for distributing perishable goods in mobile storage containers, said system comprising:
a remote central control station; and
a plurality of local control units, each local control unit being configured to be mounted on an individual mobile storage container and to control at least one controlled condition within the mobile storage container based upon control parameters(s) received from the remote central control station;
wherein control parameters from the remote central control station are provided to each of the local control units to control controlled conditions within the mobile storage containers, said control parameters being selected to respond to changes in external conditions or transport plans.

17. A system as in claim 16, wherein the control parameters are wirelessly transmitted to each of the local control units.

18. A system as in claim 16, wherein the local control units control at least two controlled conditions within the mobile storage container.

19. A system as in claim 16, wherein the control parameters(s) change the controlled condition(s) to control at least one of time to ripeness, pathogen growth, insect growth, decay control, fungal growth, and mold growth.

20. A system as in claim 16, wherein the external factors include scheduling factors, nature of the perishable goods, a harvesting condition of the perishable goods, a pre-shipment condition of the perishable goods, a route of shipment, a change of shipment route, an event during shipment, regulatory requirements, and instructions from a receiver of the perishable goods.

21. A system as in claim 16, further comprising means for measuring controlled conditions within each mobile storage container and for transmitting the measured values to the remote central control station.

22. A system as in claim 21, wherein the remote central control station generates control parameters based at least partly on the measured controlled conditions.

23. A method for configuring mobile storage containers on a transportation vehicle, said method comprising
providing a plurality of mobile storage containers at an originating location, wherein at least some of the mobile storage containers have local control units and at least some of the local control units are configured to control local control parameters which are different than the local control parameters controlled by others of the plurality of mobile storage containers; and
providing information including an amount of a perishable commodity to be transported from said originating location to one or more destination locations to a remote central control station;
wherein the remote central control station assigns portions of the perishable commodity to specific mobile storage containers based at least partly on an ability of the local control unit to preserve the perishable commodity during transportation from the originating location to the destination location.

24. A method as in claim 23, wherein the remote central control station instructs the local control units of at least some of the mobile storage containers to perform pre-trip inspections to determine if the container is in condition to carry the perishable commodity.

25. A method as in claim 24, wherein the remote central control station provides one or more local control parameters to individual local control units, wherein the local control parameter(s) may differ for different local control units based on the nature of the commodity and/or the destination location.

26. A method as in claim 25, wherein the remote central control station sends an alert to the originating location to inspect when a mobile storage container fails the pre-trip inspection.

27. A method for controlled ripening of a perishable commodity during transport in a mobile storage container, said method comprising:
monitoring ambient conditions within the mobile storage container during transport from an originating location to a destination location;
monitoring ripeness of the perishable commodity during transport form the originating location to the destination location; and
adjusting ambient conditions within the mobile storage container so that the perishable commodity reaches a target level of ripeness when the mobile storage container reaches the destination location.

28. A method as in claim 27, further comprising perturbing at least one ambient condition to see an effect on at least one ripeness marker which is being monitored.

29. A method as in claim 28, wherein ambient conditions being monitored include at least some of temperature, humidity, CO₂, concentration, ethylene concentration, and oxygen concentration.

30. A method as in claim 27, wherein monitoring ripeness comprises monitoring ambient ethylene concentration, changes in CO₂ or oxygen concentration, or other combinations of parameters within the mobile storage container.

31. A method as in claim 27, wherein adjusting ambient conditioning comprises adjusting ambient temperature within the mobile storage container.

32. A method as in claim 27, further comprising determining an adjustment in ambient condition necessary to achieve the target level of ripeness in a remote central control station, wherein a local control unit in the mobile storage container monitors the ambient conditions and ripeness and transmits data to the remote central control section and wherein the remote central control section transmits data to the local controller to adjust ambient conditions within the mobile storage container to achieve the target level of ripeness.

33. A method as in claim 27, further comprising providing information regarding scheduling factors, nature of the perishable goods, a harvesting condition of the perishable goods, a pre-shipment condition of the perishable goods, a route of shipment, a change of shipment route, an event during shipment, regulatory requirements, and/or instructions from a receiver of the perishable goods to the remote central control station, wherein the remote central control station can use at least some of this information to determine the adjustment in ambient conditions.

34. A method for cold treating perishable goods during transport from an originating location to a destination location, said method comprising
providing a required cold treatment protocol to a remote central control station; and
monitoring temperature within a mobile storage container which holds the perishable goods during transport and transmitting the monitored temperature to the remote central control station;
wherein the remote central control station compares the monitored temperature with the required cold treatment protocol and transmits a temperature control signal to a local control unit in the mobile transport container in order to maintain or adjust the temperature within the mobile transport container to complete the cold treatment protocol before the mobile transport container is unloaded at the destination location.

35. A method as in claim 34, wherein the remote central control station terminates the cold treatment protocol after a target temperature profile has been achieved.

36. A method as in claim 34, wherein the remote central control station decreases the temperature in the mobile storage container if it appears the target temperature profile will not be achieved before the mobile storage container reaches its destination location.

37. A method as in claim 34, further comprising recording temperature information in the remote central control station and generating a cold treatment report for the individual mobile storage container after the container has reached its destination location.

38. A network for distributing perishable goods in a plurality of mobile storage containers carried by a multiplicity of transportation vehicles in real time, said network comprising
a remote central control station configured to receive data concerning perishable goods to be transported from originating locations to destination locations;
a loading facility control station configured to transmit data to and receive data from the remote central control station; and
a plurality of local control units, each local control unit being configured to be mounted on an individual mobile storage container and to control and monitor conditions within the storage container and being configured to transmit data to and receive data from the loading facility control station.

39. A network as in claim 38, wherein the remote central control station transmits data to the loading facility control station including assignment of particular perishable goods to be loaded into particular mobile storage containers.

40. A network as in claim 38, wherein the loading facility control station transmits data to the remote central control station including the identity of particular mobile storage containers which are available to transport particular perishable goods.

41. A network as in claim 38, wherein the remote central control station transmits data to the loading facility control station including local control parameters for particular mobile storage containers and the remote central control station transmits the local control parameter data to the local controllers for the particular mobile storage containers.

42. A network as in claim 38, further comprising a transportation vehicle control station configured to receive data from and transmit data to the remote central control station and to receive data from and transmit data to the local control units.

43. A network as in claim 38, wherein the data transmitted from the remote central control station to the transportation vehicle control station includes local control parameters.
